(19) United States
(12) Patent Application Publication
(10) Pub. No.: US 2007/0237606 A1
(43) Pub. Date: Oct. 11, 2007

(54) Screw for composite building materials

(76) Inventor: Seiichirou Takasaki, Osaka (JP)

Correspondence Address: MARGER JOHNSON & MCCOLLOM, P.C., 210 SW MORRISON STREET, SUITE 400, PORTLAND, OR, 97204, US

(21) Appl. No.: 11/402,635

(22) Filed: Apr. 11, 2006

(51) Int. Cl. F16B 25/10

(52) U.S. Cl. 411/387.2

(57) ABSTRACT

A screw includes a lower set of cutting threads and an upper set of storage threads, the latter having a larger diameter than the cutting threads. The underside of the head includes an annular groove formed thereabout. A countersink feature is disposed between the underside of the head and the shaft of the screw. It includes a plurality of cutting ribs and a curved surface disposed between each rib pair thereby defining a groove. When the screw is installed in a composite wood-plastic material, cuttings cut by the cutting threads move upwardly and are stored between adjacent storage threads. Material cut by the countersink feature is pushed down the grooves. A space between the countersink feature and the storage threads provides additional room for storing cuttings. As a result, cuttings are retained in the bore thus preventing bulging of the surface around the bore.

### BACKGROUND OF THE INVENTION

1. Field of the Invention

The present invention relates to a screw for use with composite materials such as decking and railing products that are molded from a mixture of plastic and wood.

2. Description of the Related Art

One such screw is disclosed in U.S. Pat. No. 6,000,892. That screw works well with prior molded products, which include a mixture of approximately 60% of plastic, such as polyvinylchloride, and 40% wood chips. More recently, however, molded materials have much higher proportions of plastic to wood, e.g., 80% plastic and 20% wood. These newer products are much harder and denser than the prior 60% plastic/40% wood products. Prior art screws are not well-suited for use with the new higher density products.

For example, the new high density products require much higher torque, especially during the latter stages of driving a screw into its final position in which the head is flush with the surface of the product. This causes excessive wear on battery operated screwdrivers, which are often used to install these molded products. In addition, in the latter stages of screw installation, the torque near the screw head can be high enough to break the head off. Finally, the higher density products are more susceptible to the bulging problem described in U.S. Pat. No. 6,000,892. This relates to the bulge at the surface of the product that forms around the circumference of the screw as it is driven in. It is believed that this bulge results from wood chips cut by the lower threads. These chips are apparently forced up the bore and push up the surface around the circumference of the screw.

While the prior art screw in U.S. Pat. No. 6,000,892 was ideal for overcoming this problem in the lower density products, it is desirable to further address this problem in the higher density materials along with other problems that result from using the hard, higher density product.

It would also be desirable to incorporate a countersinking feature into the screw.

### BRIEF DESCRIPTION OF THE DRAWINGS

FIG. 1 is a perspective cross-sectional view of the underside of a prior art countersinking screw.

FIG. 2 is a side elevation view of a screw constructed in accordance with the present invention.

FIG. 3 is an enlarged partially broken-away view of the screw of FIG. 2.

FIG. 4 is a view of the screw of FIG. 2 similar to the view of the prior art screw depicted in FIG. 1.

FIG. 5 is a cross-sectional view taken along line 5-5 in FIG. 3.

FIG. 6 is a cross-sectional view taken along line 6-6 in FIG. 3.

FIG. 7 is a cross-sectional view taken along line 7-7 in FIG. 3.

FIG. 8 is a view of the screw of FIG. 2 driven through a molded product and starting into an underlying wood joist, the product and joist being in cross section.

FIG. 9 is an enlarged partially broken-away view similar to FIG. 8 with the screw being further driven in.

FIG. 10 is a view similar to FIG. 9 with the screw being still further driven in.

FIG. 11 is a view similar to FIG. 10 with the screw being installed in its final position.

### DETAILED DESCRIPTION

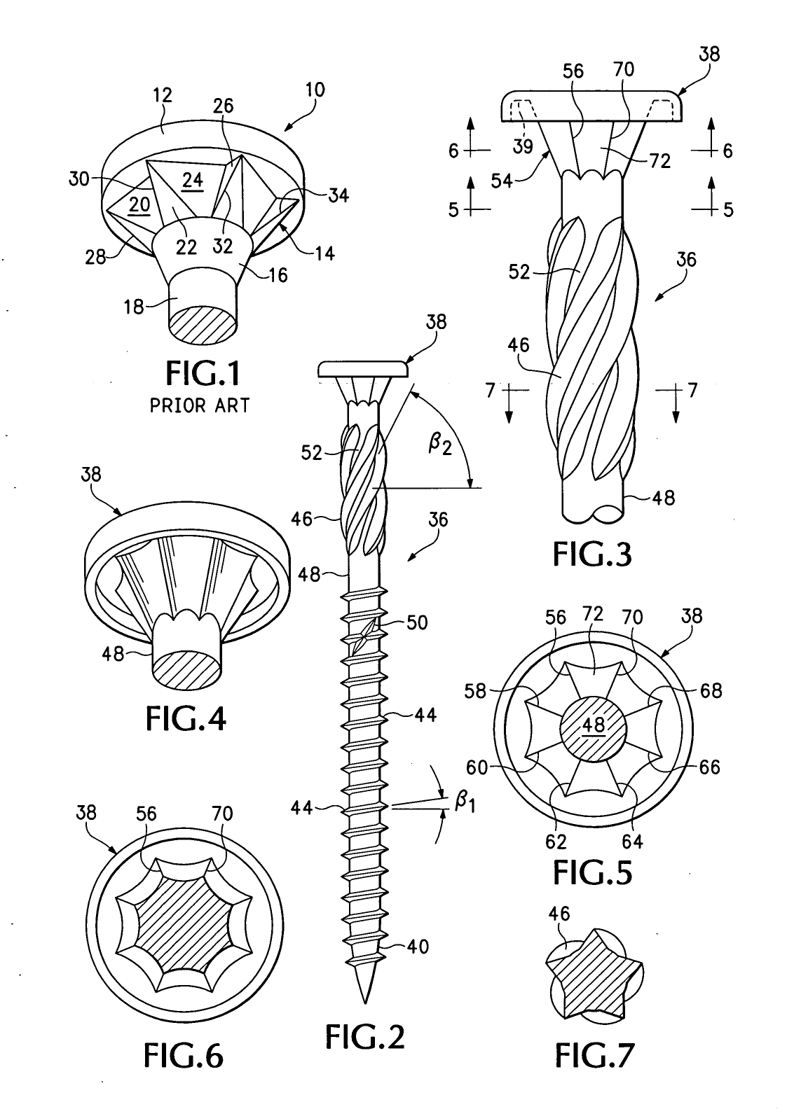

Turning first to FIG. 1, indicated generally at 10, is the upper portion of the prior art screw. The screw includes a head 12, a self countersinking feature 14, and a transitional frusto-conical portion 16 disposed between countersinking feature 14 and a shaft 18 of the screw.

Countersinking feature 14 includes a plurality of planar surfaces, like surfaces 20, 22, 24, 26. At the juncture of some of these surfaces, a cutting corner, like corners 28, 30, 32, 34, is formed.

As the screw of FIG. 1 is driven into a piece of wood, the cutting corners surrounding the screw scrape against the upper surface of the bore and gradually cut a countersunk hole into the upper portion of a bore created by the threads of screw 10 while it drives into its final position. This countersunk hole permits head 12 to be drawn further down into the bore and ideally to the point where the upper surface of head 12 is flush with the surface of the bore.

Turning now to FIG. 2, indicated generally at 36 is a screw constructed in accordance with the present invention. The screw includes a head 38, having an annular groove 39 formed on its underside; a tapered portion 40; and a straight portion that is disposed between head 38 and tapered portion 40. Tapered portion 40 and the straight portion together make up a shank. A set of cutting threads 44 and a set of storage threads 46 are formed on the shank. An unthreaded portion 48 of the shank separates cutting threads 44 and storage threads 46. A pair of helical ribs, one of which is helical rib 50, is formed on the shank along cutting threads 44. The other helical rib (not visible) is approximately 180 degrees around the circumference of the shank from helical rib 50. These ribs are generally constructed and function as the helical ribs disclosed in U.S. Pat. No. 6,000,892 which is incorporated herein by reference.

As can be seen in FIG. 2, the lead angle β₁ of cutting threads 44 is substantially smaller than the lead angle β₂ of storage threads 46. In addition, the diameter of cutting threads 44 is smaller than the diameter of cutting threads 46.

As can be seen in FIG. 2, there is a separation or space 52 between each of storage threads 46. The volume of the space between each pair of adjacent threads 46 is affected by the length of the threads and the depth of the threads, i.e., the distance from the radially outermost portion of cutting threads 46 to shank 48.

Turning again to FIG. 3, a cutter 54 is formed between the underside of head 38 and shank 48. The cutter includes eight cutting ribs, like ribs 56, 58, 60, 62, 64, 66, 68, 70, which are equally spaced about the circumference of the screw. Between each pair of ribs is a curved surface, like surface 72 between ribs 56, 70. Each curved surface defines a groove between adjacent pairs of cutting ribs such as the groove bounded by ribs 56, 70 and surface 72.

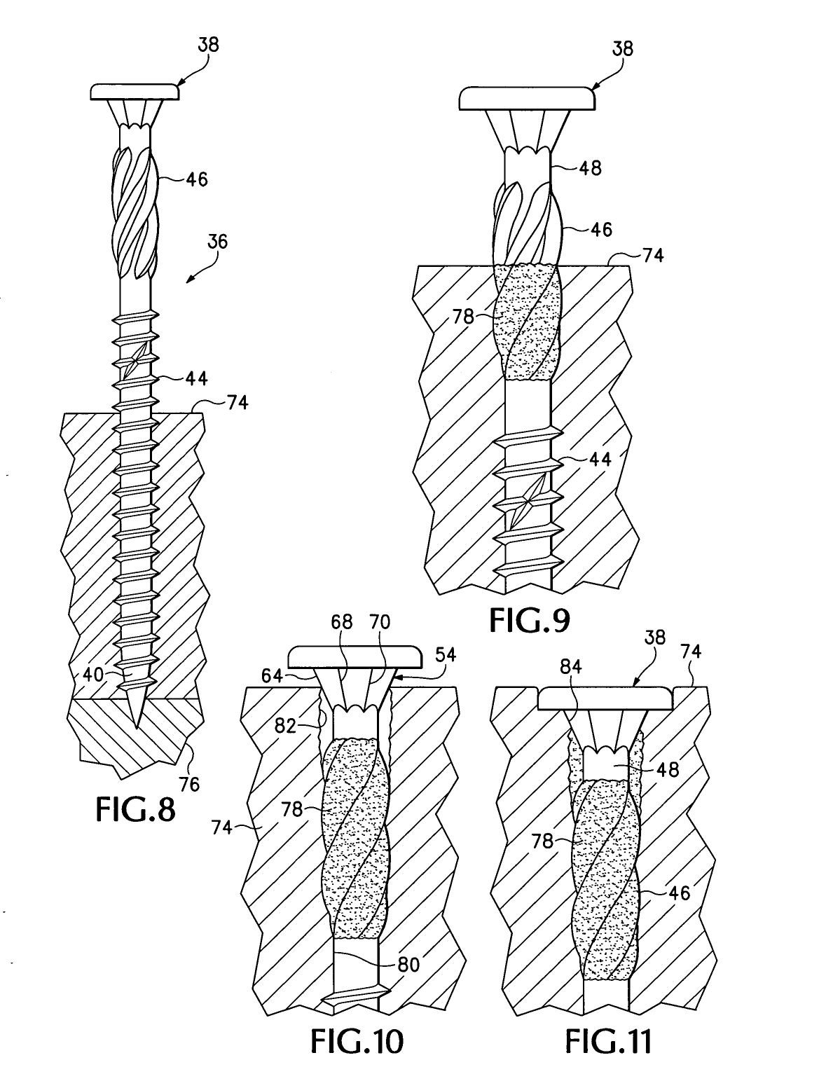

Consideration will now be given, with reference to FIGS. 8-11, to how screw 36 is used to join a hard, high-density molded composite member 74 to an underlying wood joist 76. When screw 36 is driven into member 74, tapered portion 40 penetrates the upper surface and cuts a bore therethrough in response to rotation and downward pressure applied to head 38. Although screw 36 may be installed manually, it is well-suited for installation with a conventional electric or battery driven driver that can engage head 38 in any manner. As the screw advances, threads 44 are received in the bore cut by the threads. This action is similar to that for the screw disclosed in U.S. Pat. No. 6,000,892.

With reference to FIG. 9, as the lower end of storage threads 46 engage the upper end of the bore cut by threads 44, a larger diameter bore, defined by the outer diameter of thread 46, is formed. As can be seen in FIG. 9, cuttings 78, some of which are cut by threads 44, move upwardly in the bore and are received within the spaces defined between adjacent storage threads 46. In addition, material cut by the scraping action of threads 46 against the radially outer surface of the already-formed bore is also received between threads 46. As can be seen in FIG. 10, the bore cut by screw 36 includes two separate portions 80, 82, with portion 80 being formed with cutting threads 44 and portion 82 being additionally formed with storage threads 46. This produces a bore having a lower smaller diameter, namely portion 80, and a larger upper diameter, namely portion 82.

As can best be seen in FIG. 10, when the ribs, like ribs 64, 68, 70, first contact the radially outer surface of bore 82, they begin to form a countersunk portion 84 (in FIG. 11) of the bore. As the ribs scrape against the surface of the bore, cuttings fall into the various grooves between each pair of adjacent ribs. Further downward screwing action forces the cuttings down each groove into the space between cutter 54 and cutting threads 46. Some of these cuttings may be pushed downwardly until they are received between adjacent threads 46. In addition, some of the cuttings may be retained within the grooves on the cutter, as seen in FIG. 11. Annular groove 39 (visible in FIG. 3) formed on the underside of head 38 is able to receive any portion of the upper surface that may have bulged as a result of cuttings moving upwardly toward the surface. As a result, even if some bulging does occur, screw 36 may still be installed as shown in FIG. 11, with the upper surface of head 38 substantially flush with the upper surface of member 74.

Because of the high plastic content in member 74 and the large lead angle of storage threads 46, substantial scraping, as opposed to cutting, occurs between storage threads 46 and the outer surface of the bore. This produces heat, which in turn tends to melt the cuttings. Likewise, cutter 54 tends to scrape, therefore generating heat and melting plastic in the cuttings cut by cutter 54. The cuttings remain at least soft if not substantially molten while the screw is being installed. After installation, the cuttings cool and harden. This produces a larger holding force between member 74 and joist 76 than provided by the screw threads on their own.

Having described and illustrated the principles of the invention in a preferred embodiment thereof, it should be apparent that the invention can be modified in arrangement and detail without departing from such principles. I claim all modifications and variation coming within the spirit and scope of the following claims.

1. A screw for creating a countersunk hole as the screw is driven in, comprising:
a shank;
a head having a substantially flat underside;
a cutter having a generally frusto-conical shape disposed between the shank and the head;
a plurality of cutting ribs disposed on the cutter about the circumference thereof, the cutting ribs disposed between the underside of the head and the shank; and
a groove having a curved cross section disposed between each adjacent pair of cutting ribs.

2. The screw of claim 1 wherein the head includes a substantially annular groove formed on the underside thereof around the cutter.

3. The screw of claim 1 wherein the screw includes 8 cutting ribs that are substantially equally disposed on the cutter about the circumference thereof.

4. A countersink formed on the underside of a screw head comprising:
a plurality of cutting ribs extending downwardly from the screw head between a first radially outer location to a second location that is radially inward from the first location; and
a curved surface disposed between each pair of adjacent ribs, each rib pair and associated surface defining a groove having a cross-sectional area that decreases between the first and second locations.

5. The screw of claim 4 wherein the screw includes 8 cutting ribs that are substantially equally disposed on the cutter about the circumference thereof.

6. A screw of the type having a straight portion, a tapered portion at a lower end of the straight portion and a head at an upper end the straight portion, the screw comprising:
a set of cutting threads extending upwardly from the tip, the cutting threads forming a bore by cutting away portions of material as the screw is screwed into the material; and
a set of storage threads disposed between the cutting threads and the head, the storage threads being of a length, diameter, and depth to store substantially all of the material cut by the cutting threads when the screw head is screwed substantially flush against a surface of the material.

7. The screw of claim 6 wherein the material comprises plastic material having wood chips mixed therein.

8. The screw of claim 6 wherein the lead angle of the storage threads is substantially larger than the lead angle of the cutting threads.

9. The screw of claim 8 wherein the diameter of the storage threads is substantially larger than the diameter of the cutting threads.

10. The screw of claim 6 wherein the diameter of the storage threads is substantially larger than the diameter of the cutting threads.

11. The screw of claim 10 wherein there is a space between the radially innermost ends of each adjacent pair of threads.

12. The screw of claim 6 which further includes a countersink formed on the underside of the head.

13. A method of screwing a screw into material comprising:
start screwing with a tip having a set of cutting threads extending upwardly therefrom;
generating bits of cut material in a bore made as the cutting threads advance;
continuing screwing until the cutting threads are received within the bore;
engaging a set of storage threads with the bore;
continuing screwing until the storage threads are received within the bore; and
receiving substantially all of the bits of cut material in the storage threads.

14. The method of claim 13 wherein the storage threads have a substantially larger diameter than the cutting threads and the method further comprises:
scraping the bore with the radially outer surface of the storage threads; and
generating enough heat responsive to the scraping to melt the plastic in the bits of cut material.

15. The method of claim 13 wherein the method further comprises cutting a countersink bore into the material after the storage threads are received within the bore.

16. The method of claim 15 wherein the method further comprises:
generating bits of cut material in the countersink bore as the countersink bore is cut; and
driving the bits of cut material in the countersink bore downwardly as the cutting threads further advance.
